(19) United States
(12) Patent Application Publication
(10) Pub. No.: US 2009/0224640 A1
(43) Pub. Date: Sep. 10, 2009

(54) CHASSIS STRUCTURE OF ELECTRONIC DEVICE

(75) Inventors: Chun-Yu Yang, Taipei (TW); Chun-Ying Yang, Taipei (TW); Yi-Hsuan Chen, Taipei (TW); Ming-Hung Shih, Taipei (TW); Chun-Hsien Wu, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/099,295

(22) Filed: Apr. 8, 2008

(30) Foreign Application Priority Data
Feb. 20, 2008 (TW) 097105865

(51) Int. Cl. A47B 81/00; G06F 1/16

(52) U.S. Cl. 312/223.2; 361/679.33

(57) ABSTRACT

A chassis structure of an electronic device includes a chassis and two hard disk drive (HDD) mobile racks of different sizes. The chassis has two expansion slots of different sizes. The smaller mobile rack carries a plurality of hard disk drives and is directly installed into the smaller expansion slot. Alternatively, the smaller mobile rack carrying the hard disk drives may also be first assembled into the larger mobile rack and then installed into the larger expansion slot together with the larger mobile rack, such that the hard disk drives are installed into all the expansion slots in the chassis.

### CROSS-REFERENCE TO RELATED APPLICATIONS

This non-provisional application claims priority under 35 U.S.C. §119(a) on Patent Application No(s). 097105865 filed in Taiwan, R.O.C. on Feb. 20, 2008, the entire contents of which are hereby incorporated by reference.

### BACKGROUND OF THE INVENTION

1. Field of the Invention

The present invention relates to a chassis of an electronic device, and more particularly to a chassis structure of an electronic device having a modulized swap tray for hard disks.

2. Related Art

A host for servers and industrial computers requires a sufficient large data storage capacity to store work items and using information or to output they at any time. Therefore, a chassis of the host for the servers and industrial computers must be disposed with many expansion slots for installing storage devices. Such expansion slots are provided for a user to rapidly replace hard disk drives or optical disk drives directly from the exterior of the chassis, so that the mounting and dismounting procedures become quite easy and convenient. The expansion slots are mainly enclosed by rack mounts within the chassis, so as to form suitable expansion slots for storage devices with different sizes. Currently, the commonly used storage devices in the field generally have two major standard sizes of 3.5″ and 2.5″. Therefore, most hosts for servers and industrial computers are disposed with rack mounts respectively matching with such two standard sizes, and the expansion slots for installing the 3.5″ and 2.5″ storage devices are provided in the chassis.

As for the current trend of storage devices, most optical disk drives are in a specification of 3.5″, whereas the early specification of 3.5″ for the hard disk drives has already been replaced by the specification of 2.5″ with a smaller volume, so as to enhance the utilization of the space within the chassis, which is especially important for the servers and industrial computers. That is to say, although the hard disk drive has been gradually turned into the specification of 2.5″, the optical disk drive still maintains the specification of 3.5″. In this case, both the expansion slots at such two specifications are still required to be maintained in the chassis of the host. However, due to the changes in the usage requirements, the user of the server and industrial computer needs to frequently change the hard disk drive and the optical disk drive. Such that the hard disk drive at the specification of 2.5″ cannot be installed into the expansion slot at the specification of 3.5″ due to the limitation in the size of the expansion slots, which always brings about inconveniences in replacing the hard disk drive, and thus all the spaces in the chassis cannot be effectively and sufficiently utilized. For this reason, some manufacturers have designed specific mobile racks of different sizes for the 2.5″ hard disk drive, and in this way, the 2.5″ hard disk drive not only can be installed in the 3.5″ expansion slot through the 3.5″ mobile rack, but also can be installed in the 2.5″ expansion slot through the 2.5″ mobile rack. However, in such a solution, two mobile racks must be manufactured respectively, which causes an excessive high cost in developing and producing the chassis. Moreover, the hard disk drive must be detached from one mobile rack before being mounted to another mobile rack during the replacement, which still brings troubles in the dismounting and mounting procedures.

### SUMMARY OF THE INVENTION

In view of the above problems, the present invention is mainly directed to a chassis structure of an electronic device, so as to solve the problems in the prior art that the chassis of the host has a poor space utilization and the development cost is excessively high.

In order to solve the above problems, the present invention provides a chassis structure of an electronic device, applied for accommodating a plurality of storage devices, in which the storage devices may not be limited to 2.5″ hard disk drives. The chassis structure includes a chassis, at least one first mobile rack, and at least one second mobile rack. The chassis at least has a first expansion slot and a second expansion slot, in which the chassis may be, but not limited to, a chassis of a host for servers or industrial computers, and the first expansion slot and the second expansion slot are expansion slots of different sizes in the servers or industrial computers. The first mobile rack is detachably disposed in the first expansion slot of the chassis, and the second mobile rack is used for carrying the storage devices. The second mobile rack may be directly placed into the second expansion slot, so as to assemble the storage devices into the second expansion slot of the chassis. Alternatively, the second mobile rack may be assembled into the first mobile rack and then placed into the first expansion slot together with the first mobile rack, so as to assemble the storage devices into the first expansion slot of the chassis. Thus, the storage devices of a single size can be respectively mounted into two expansion slots of different sizes through using the first mobile rack and the second mobile rack.

The efficacy of the present invention lies in that, the storage devices can be respectively mounted into the expansion slots of different specifications by using the second mobile rack or using a combination of the first mobile rack and the second mobile rack, so as to enhance the utilization of the space within the chassis and to reduce the cost for developing the chassis.

### BRIEF DESCRIPTION OF THE DRAWINGS

The present invention will become more fully understood from the detailed description given herein below for illustration only, which thus is not limitative of the present invention, and wherein:

FIG. 1 is a schematic three-dimensional view of a second mobile rack and storage devices in the present invention;

FIG. 2 is an exploded three-dimensional view of the second mobile rack and a first mobile rack in the present invention;

FIG. 3 is a schematic three-dimensional view of a chassis in the present invention;

FIG. 4 is an exploded three-dimensional view of the second mobile rack and the chassis in the present invention;

FIG. 5 is a schematic three-dimensional view of the first mobile rack and the storage devices in the present invention;

FIG. 6 is a partial schematic cross-sectional view of the first mobile rack, the second mobile rack, and the chassis in the present invention;

FIG. 7 is a partial schematic cross-sectional view of the first mobile rack, the second mobile rack, and the chassis in the present invention;

FIG. 8 is a partial schematic cross-sectional view of the first mobile rack, the second mobile rack, and the chassis in the present invention; and

FIG. 9 is a schematic three-dimensional view of the first mobile rack and the second mobile rack assembled to the chassis in the present invention.

### DETAILED DESCRIPTION OF THE INVENTION

To make the objectives, structures, features, and functions of the present invention become more comprehensible, the present invention is illustrated below in detail through the embodiments.

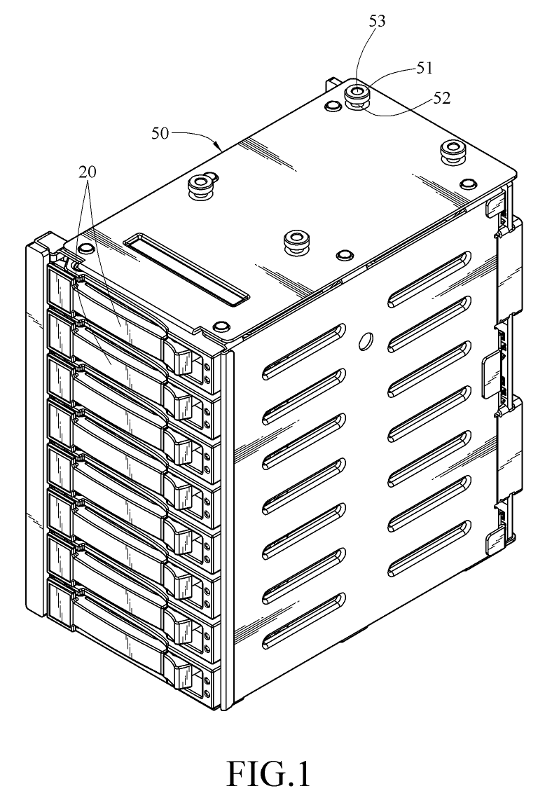

Referring to FIGS. 1, 2, and 3, they show a chassis structure of an electronic device according to the present invention. The chassis structure includes a chassis 10, a plurality of first mobile racks 30, and a plurality of second mobile racks 50 and it is used for accommodating a plurality of storage devices 20. The chassis 10 may be, but not limited to, a chassis of a host for servers or industrial computers, and the storage devices 20 may be, but not limited to, 2.5″ hard disk drives. The number of the first mobile racks 30 and the second mobile racks 50 that are allocated may be increased or decreased depending upon the actual demands, which is not limited by the figures. Merely one first mobile rack 30 and one second mobile rack 50 are required for implementing the present invention.

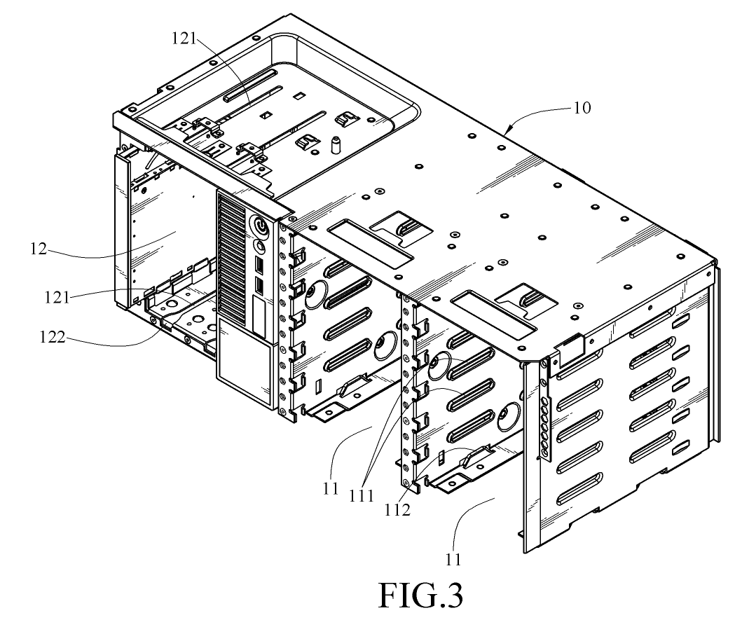

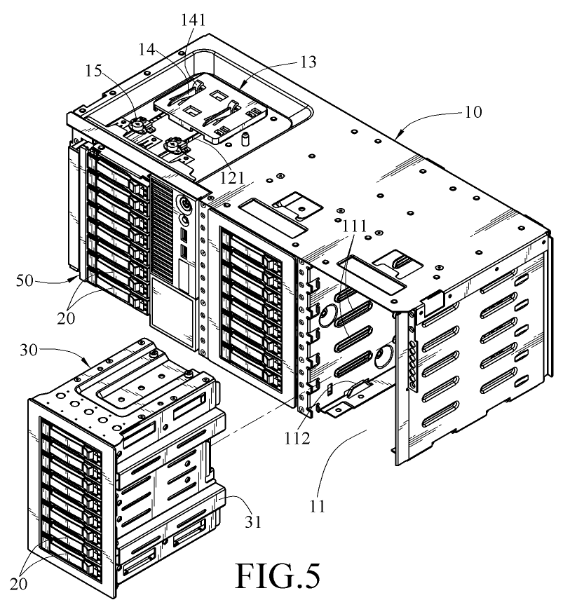

Referring to FIGS. 3, 4, and 5, the chassis 10 has two first expansion slots 11 and one second expansion slot 12, in which the first expansion slots 11 and the second expansion slot 12 are respectively expansion slots of different sizes in the hosts of the servers or industrial computers. In a preferred embodiment of the present invention, the first expansion slots 11 are exclusively provided for 3.5″ hard disk drives or optical disk drives, whereas the second expansion slot 12 is exclusively provided for 2.5″ hard disk drives. The first expansion slots 11 have a plurality of guide portions 111 arranged side by side and a plurality of urging portions 112 on an inner wall thereof The second expansion slot 12 has a plurality of guide channels 121 on an inner wall thereof. Each of the guide channels 121 has a wider opening 122 at an edge of the second expansion slot 12. The guide channels 121 are disposed on two opposite inner walls of the second expansion slot 12. The number of the guide channels 121 that are allocated may be increased or decreased depending upon the actual demands, which is not limited by the figures. Merely one guide channel 121 is sufficient for implementing the present invention.

The chassis 10 has a stopper plate 13 and a plurality of fixing parts 15, in which the number of the stopper plate 13 is increased or decreased depending upon the number of the second expansion slot 12. The stopper plate 13 is disposed at one side of the second expansion slot 12 corresponding to the guide channels 121. The stopper plate 13 has two elastic arms 14 extending towards the guide channels 121, in which the number of the elastic arms 14 is increased or decreased depending upon the number of the guide channels 121. Each elastic arm 14 has an actuating portion 141 at an end edge thereof, and the actuating portion 141 is flipped to drive the elastic arm 14 to be deformed towards a direction opposite to the second expansion slot 12, so as to enlarge the gap between the elastic arm 14 and the corresponding guide channel 121.

Referring to FIGS. 1 to 5, each second mobile rack 50 for carrying the storage devices 20 has a plurality of positioning pillars 51 thereon. Each positioning pillar 51 has a screw hole 53 at the top thereof and has an annular slot 52 at the bottom. The second mobile rack 50 may be directly placed into the second expansion slot 12 of the chassis 10, so as to assemble the storage devices 20 into the second expansion slot 12 of the chassis 10. When placing the second mobile rack 50 into the second expansion slot 12, the positioning pillars 51 slide along the corresponding guide channels 121 by the annular slots 52 at the bottom thereof, thereby guiding the second mobile rack 50 into the second expansion slot 12 of the chassis 10.

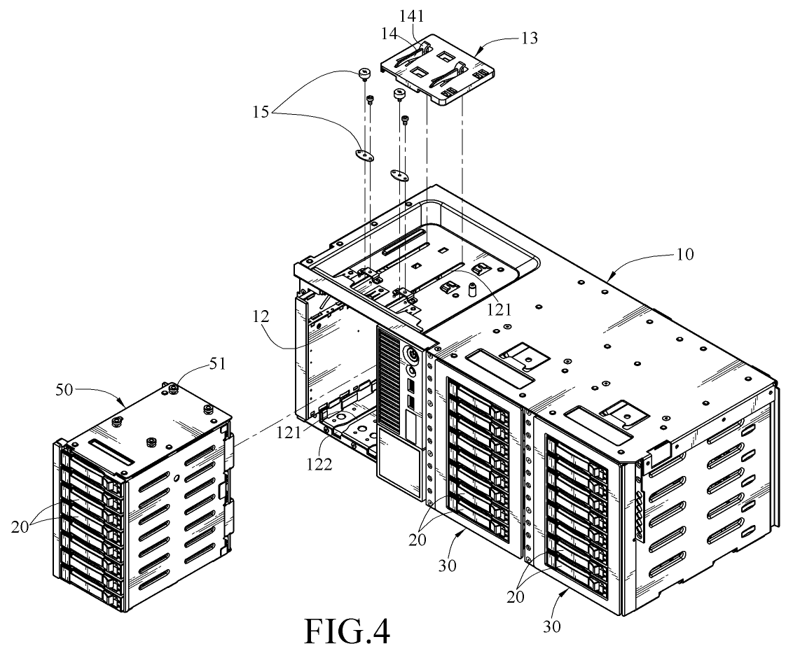

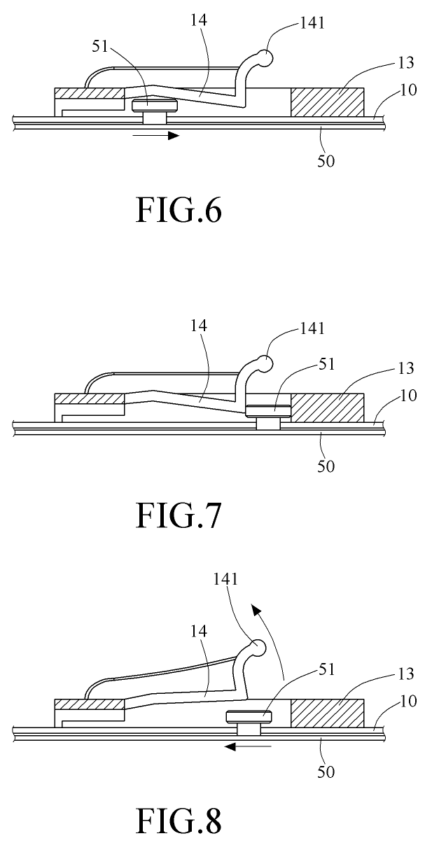

Referring to FIGS. 4, 5, 6, 7, and 8, when the positioning pillars 51 slide along the guide channels 121 to guide the second mobile rack 50 into the second expansion slot 12, the positioning pillars 51 contact with the elastic arms 14 and push the elastic arms 14 outwards. Then, the elastic arms 14 catch the positioning pillars 51, so as to fix the second mobile rack 50 in the second expansion slot 12. In order to further fix the second mobile rack 50, the fixing parts 15 are made to pass though the guide channels 121 and screwed into the screw holes 53 at the top of the positioning pillars 51, so as to fix the second mobile rack 50 in the chassis 10 more firmly. When the second mobile rack 50 is intended to be withdrawn out of the second expansion slot 12, the user only needs to dismount the fixing parts 15 and then flip the elastic arms 14 with the actuating portions 141, such that the elastic arms 14 are deformed outwards to release the positioning pillars 51 accordingly, thereby withdrawing the second mobile rack 50 out of the second expansion slot 12.

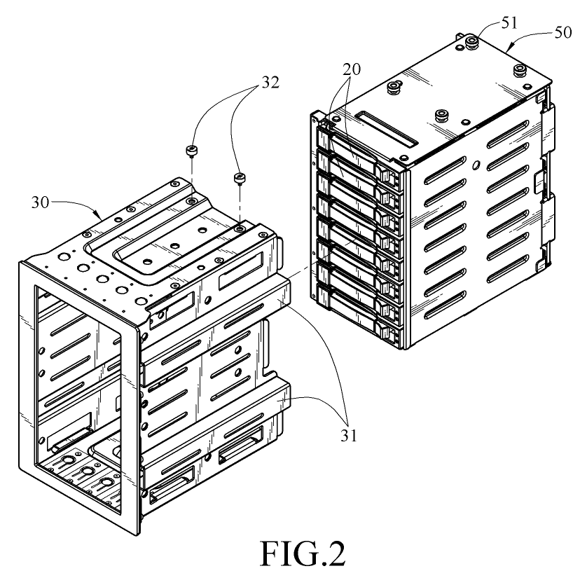

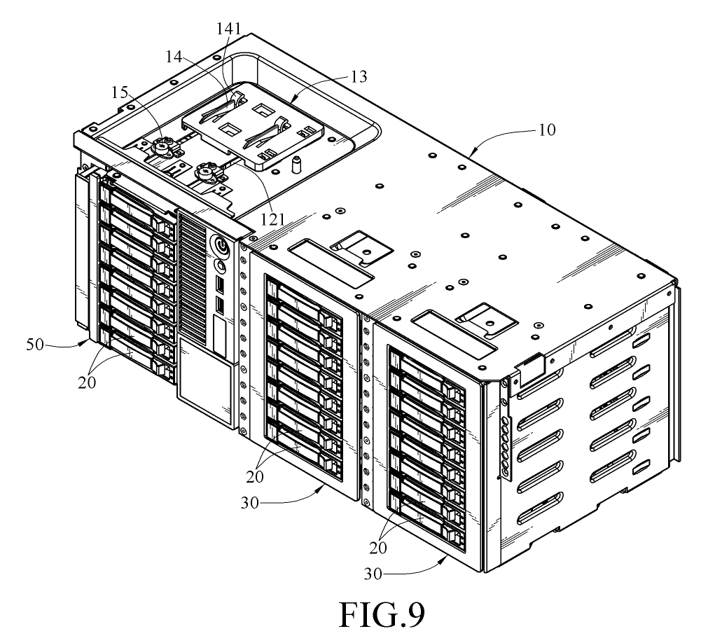

Referring to FIGS. 2, 5, and 9, the second mobile rack 50 may also be assembled into the first mobile rack 30 and then placed into the first expansion slot 11 together with the first mobile rack 30, so as to assemble the storage devices 20 in the first expansion slot 11 of the chassis 10. The first mobile rack 30 is detachably disposed in the first expansion slot 11 of the chassis 10 and has a plurality of protrusions 31 and a plurality of screwing parts 32 at both sides thereof. When installing the second mobile rack 50 into the first mobile rack 30, the screwing parts 32 pass through the first mobile rack 30 and screwed into the screw holes of the positioning pillars 51, so as to fix the second mobile rack 50 in the first mobile rack 30. When placing the first mobile rack 30 into the first expansion slot 11, the protrusions 31 slide between the guide portions 111 to guide the first mobile rack 30 into the first expansion slot 11 of the chassis 10. The number of the allocated protrusions 31 may be increased or decreased depending upon the actual demands, which is not limited by the figures. Merely one protrusion 31 is sufficient for implementing the present invention. Once the first mobile rack 30 slides into the first expansion slot 11 of the chassis 10, the urging portions 112 are leaned against an edge of the first mobile rack 30 to fix the first mobile rack 30 in the first expansion slot 11 of the chassis 10 in a tight-fit manner. Thus, the storage devices 20 of a single size (2.5″) can be mounted into the second expansion slot 12 (the specification of 2.5″) of the chassis 10 through using the second mobile rack 50 or mounted into the first expansion slot 11 (the specification of 3.5″) of the chassis 10 through using the second mobile rack 50 combined within the first mobile rack 30.

In the present invention, the storage devices can be respectively mounted into the expansion slots of different specifications through using the second mobile rack or a combination of the first mobile rack and the second mobile rack, so as to improve the utilization of the space within the chassis and to reduce the cost in developing the chassis.

What is claimed is:

1. A chassis structure of an electronic device, applied for accommodating a plurality of storage devices, comprising:
a chassis, at least having a first expansion slot and a second expansion slot;
at least one first mobile rack, detachably disposed at the first expansion slot; and
at least one second mobile rack, for carrying the storage devices, wherein the second mobile rack is selectively placed into the second expansion slot, so as to assemble the storage devices into the second expansion slot; or the second mobile rack is assembled into the first mobile rack first and then placed into the first expansion slot together with the first mobile rack, so as to assemble the storage devices into the first expansion slot.

2. The chassis structure as claimed in claim 1, wherein the second expansion slot has at least one guide channel on an inner wall thereof, the first mobile rack has at least one positioning pillar, and the positioning pillar slides along the guide channel to guide the second mobile rack into the second expansion slot.

3. The chassis structure as claimed in claim 2, wherein the chassis at least has a stopper plate disposed at one side of the second expansion slot, the stopper plate has at least one elastic arm extending towards the guide channel, and the elastic arm catches with the positioning pillar to fix the second mobile rack in the second expansion slot.

4. The chassis structure as claimed in claim 3, wherein each elastic arm has an actuating portion at an end edge thereof, the actuating portion is flipped to drive the elastic arm to be deformed towards a direction opposite to the second expansion slot, so as to release the positioning pillar.

5. The chassis structure as claimed in claim 1, wherein the first expansion slot has a plurality of guide portions arranged side by side on an inner wall thereof and the first mobile rack has at least one protrusion that slides between the guide portions to guide the first mobile rack into the first expansion slot.

6. The chassis structure as claimed in claim 1, wherein the first mobile rack has at least one screwing part, the second mobile rack has at least one positioning pillar, and the screwing part is screwed into the positioning pillar after passing through the first mobile rack, so as to fix the second mobile rack in the first mobile rack.

7. The chassis structure as claimed in claim 1, wherein the first expansion slot has a plurality of urging portions on an inner wall thereof, and the urging portions are leaned against the first mobile rack by a tight-fit manner to fix the first mobile rack in the first expansion slot in a tight-fit manner.
